(19) United States
(12) Patent Application Publication
(10) Pub. No.: US 2020/0140970 A1
(43) Pub. Date: May 7, 2020

(54) AN APPARTUS AND A METHOD FOR PROCESSING STAINLESS STEEL AND AN IMPROVED STAINLESS STEEL FOR BIOIMPLANTS THEREOF

(71) Applicant: SHIV NADAR UNIVERSITY, Dadri, Uttar Pradesh (IN)

(72) Inventors: Harpreet SINGH, Dadri (IN); Harpreet Singh GREWAL, Dadri (IN); Soumya PATI, Dadri (IN); Shailja SINGH, Dadri (IN); Gopinath PERUMAL, Dadri (IN)

(21) Appl. No.: 16/631,378

(22) PCT Filed: Jan. 4, 2018
(86) PCT No.: PCT/IN2018/050005

§ 371 Date: Jan. 15, 2020

(30) Foreign Application Priority Data
Jul. 19, 2017 (IN) 201711025604

(51) Int. Cl. C21D 9/00; C21D 6/00; C21D 6/04; C22C 38/44; C22C 38/04; C22C 38/02; C22C 38/00; B23K 20/12; B23K 20/227; B23K 37/00

(52) U.S. Cl. CPC C21D 9/0062; C21D 6/004; C21D 6/04; C22C 38/44; C22C 38/04; C22C 38/02; B23K 2103/05; C22C 38/001; B23K 20/1245; B23K 20/1275; B23K 20/227; B23K 37/003; C22C 38/002

(57) ABSTRACT

The present invention provides a simple, single step and time efficient method and apparatus for developing ultrafine grained microstructure stainless steel having enhanced wear resistance, corrosion resistance, biocompatibility, cellular response and hem-compatibility for bio-implant applications. The processed stainless steel showed 50% reduction in corrosion, high resistance against localised pitting and 50% reduction in wear in simulated body fluid. In addition, the processed steel demonstrated better cell viability, significantly lower platelet adhesion and plasma adsorption signifying high thrombo-resistance and thereby making it highly desirable for bio-implant applications. The present invention eliminates the long processing steps and do not need any specialized equipments and also eliminates the post process treatments.

### FIELD OF THE INVENTION

The present invention relates to material science, In particular, the present invention relates to the processing of the stainless steel to improve the characteristic property of the metal, which can be used in advanced applications.

### BACKGROUND OF THE INVENTION

Generally, stainless steel is used widely for various purpose. Stainless steel is most commonly used material for the purpose of bio-implants because of its biocompatibility, excellent mechanical properties, and low cost. Bo-implants are exposed to harsh environment of the body and degrade typically by wear and corrosion in the physiological environment resulting in Metallosis. Wear debris and localized corrosion are considered to be the biggest cause of premature implant failure. Although non-toxic, stainless steel show significant platelet and protein adhesion when used as an implant, leading to undesirable cellular activities such as thrombogenesis. This may lead to severe inflammation, making implant unfit for human use. Limiting degradation of bio-implants by wear, corrosion and improving their bio-compatibility and cellular response are the major challenges for the development of robust bio-implants.

The existing techniques used to limit degradation of bio-implants by wear, corrosion and improving their bio-compatibility and cellular response, are based on development of surface coatings on an implant material. Coatings are generally synthesized either by solidification from the liquid melt impacted on substrate (thermal spraying) or vapor to solid (PVD/CVD etc.) leading to inherent issues of substrate dilution, porosities, un-melted zones, high thermal residual stresses resulting in poor adhesion and coating delamination, anisotropic behavior and premature failure. In addition, coatings with different chemical composition than the implant material promote localized corrosion due to the formation of micro-galvanic cells with the substrate.

Furthermore, the existing techniques are highly specific for a particular problem; either wear or corrosion or biocompatibility/cellular response. They do not provide a generic solution which can address all these issues. These techniques are costly and require a specialized equipment which limits the applicability of these processes.

However, there are few techniques in existence that can modify the surface of the parent material itself without need of developing surface coatings. These techniques have limited scope.

U.S. Pat. No. 5,782,910 discloses bio-implants having enhanced biocompatibility and hem-compatibility. However, the enhanced biocompatibility and hem-compatibility is achieved by means of coating the surface of the bio-implant. Such processes are expensive and do not provide adequate performance required from a reliable implant

U.S. patent application Ser. No. 11/090,910 discloses a solid state process on a workpiece to modify characteristics of a workpiece while substantially maintaining a solid phase. Wherein, solid state process is performed on a workpiece by using a tool capable of friction stir processing, friction stir mixing, or friction stir welding, wherein solid state processing is performed on the workpiece to modify microstructure, macrostructure, toughness, hardness, grain boundaries, grain size, the distribution of phases, ductility, superplasticity, change in nucleation site densities, compressibility, expandability, coefficient of friction, abrasion resistance, corrosion resistance, fatigue resistance, magnetic properties, strength, radiation absorption, and thermal conductivity. However, this patent does not discuss about the improvisation of the material characteristics like, biocompatibilty, cellular response and hem-compatibilty. Furthermore, high amount of heat is generated due to friction which results in grain growth and do not provide efficient control over the microstructure Material characteristic also changes, thus desired characteristics are not achieved.

Research paper titled ‘Achieving ultrafine-grained structure in a pure nickel by friction stir processing with additional cooling’ discloses a friction stir processed (FSP) using a common heat-treated steel tool under additional water cooling. This paper describes an effective low-cost method of processing high melting point metals.

Research paper titled ‘Submerged friction stir processing of AZ31 Magnesium alloy’ discloses a sub-merged friction stir processed AZ31 Magnesium samples in room-temperature and warm water.

However, the above discussed research paper is about sub-merged friction stir process on low strength material. These papers fails to address the problems in processing high strength material like stainless steel. Further, these papers do not explored the applicability of friction stir processed material for bio-implant applications.

Therefore for above reasons there is a need in the art to provide a high strain-rate deformation method for processing stainless steel resulting in an improved stainless steel having enhanced wear resistance, corrosion resistance, biocompatibility, cellular response and hem-compatibility, preferably in physiological conditions.

### OBJECTIVE OF THE INVENTION

The main objective of the present invention is to provide an improved stainless steel with ultrafine grained microstructure, which possess enhanced wear resistance, corrosion resistance, biocompatibility, cellular response and hem-compatibility.

Another objective of the present invention is to provide a high strain-rate deformation method for processing the coarse grained microstructure stainless steel into an improved stainless steel with ultrafine grained microstructure possessing enhanced wear resistance, corrosion resistance, biocompatibility, cellular response and hem-compatibility which is facile and cost effective.

Yet another objective of the present invention is to provide a facile, cost effective and time efficient high strain-rate deformation method for processing the stainless steel.

Additional objective of the present invention is to provide an apparatus which enables the performance of high strain-rate deformation method for processing the coarse grained microstructure stainless steel resulting in an improved stainless steel with ultrafine grained microstructure.

Still another objective of the present invention is to provide a high strain-rate deformation method for processing stainless steel, where solid state of the stainless steel working material is maintained, which tends to transform into liquid state due to temperature rise during high stain-rate deformation.

### SUMMARY OF THE INVENTION

The present invention provides a simple and cost effective method and apparatus for processing the stainless steel to enhance its physical characteristics including wear resistance, corrosion resistance, biocompatibilty, cellular response and hem-compatibility.

An apparatus (100) for processing the stainless steel having coarse grained microstructure, thereby generating an ultrafine grained microstructure, comprising of a work station (101), for accommodating the stainless steel working material; a fastening means, for holding the stainless steel working material in position; a spindle (102) provided with a collet and a probing pin, for processing the working material; a motor, for rotating the spindle (102) and probing pin; a controller, for controlling the operation of the said spindle (102); a chamber (103), for accommodating the working material along with the fastening means and flowing coolant; a cooling unit (106), for supplying coolant to the chamber (103), wherein said coolant is circulated through the chamber by means of inlet (104) and the means for outlet (105); and a power source, for supplying power to the said cooling unit (106), the said motor and the said work station (101). In the present invention since the stainless steel working material is completely immersed in the coolant, this prevents the temperature rise due to the high stain-rate deformation caused by the penetrated rotating probing pin. Further the present invention provides a simple, single step and time efficient method for developing ultrafine grained microstructure to enhance wear resistance, corrosion resistance, biocompatibility, cellular response and hem-compatibility of the stainless steel working material by employing the said apparatus. Furthermore, the present invention provides an improved stainless steel which is having enhanced wear resistance, corrosion resistance, biocompatibility, cellular response and hem-compatibility.

### BRIEF DESCRIPTION OF THE DIAGRAMS

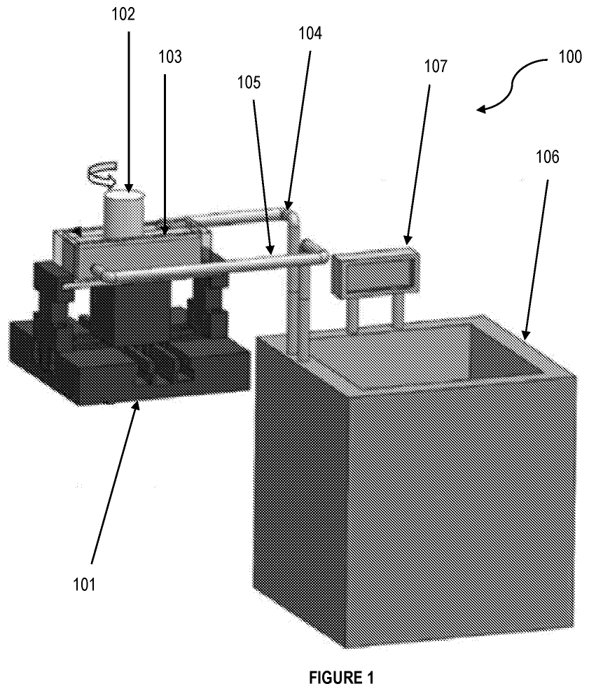

FIG. 1 shows the apparatus set-up for enabling the ultrafine grain refinement of the stainless steel material according to the present invention.

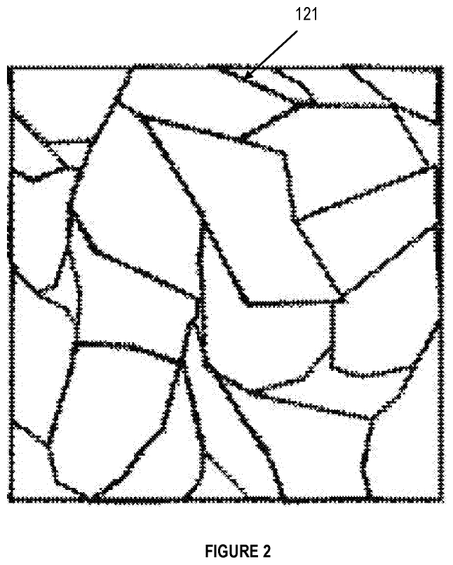

FIG. 2 depicts the coarse grained microstructure of the unprocessed stainless steel.

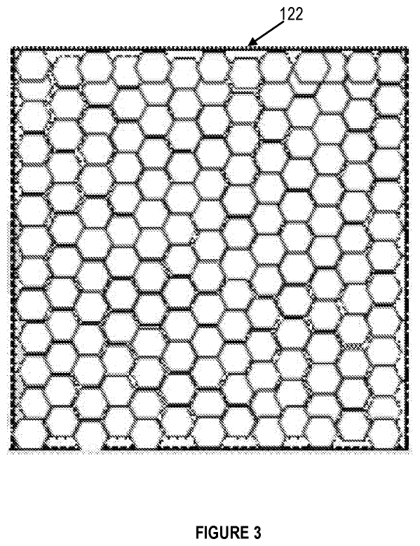

FIG. 3 illustrates the ultrafine grained microstructure of the improved stainless steel according to the present invention.

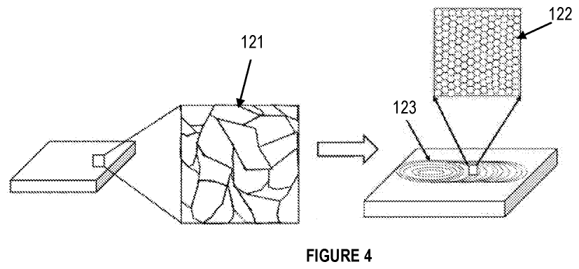

FIG. 4 illustrates the conversion coarse grained stainless steel into an ultrafine grained microstructure stainless steel according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

The present invention as embodied by a method of processing stainless steel and an improved stainless steel thereof, succinctly fulfils the above-mentioned need(s) in the art. The present invention has objective(s) arising as a result of the above-mentioned need(s), said objective(s) being enumerated below. In as much as the objective(s) of the present invention are enumerated, it will be obvious to a person skilled in the art that, the enumerated objective(s) are not exhaustive of the present invention in its entirety, and are enclosed solely for the purpose of illustration. Further, the present invention encloses within its scope and purview, any structural alternative(s) and/or any functional equivalent(s) even though, such structural alternative(s) and/or any functional equivalent(s) are not mentioned explicitly herein or elsewhere, in the present disclosure. The present invention therefore encompasses also, any improvisation(s)/modification(s) applied to the structural alternative(s)/functional alternative(s) within its scope and purview. The present invention may be embodied in other specific form(s) without departing from the spirit or essential attributes thereof.

Throughout this specification, the use of the word ‘comprise’ and variations such as “comprises” and “comprising” may imply the inclusion of an element or elements not specifically recited.

The present invention provides an apparatus (100) for processing the coarse grained stainless steel into a ultrafine grained stainless steel with enhanced wear resistance, corrosion resistance, biocompatibility, cellular response and hem-compatibility, comprises of a work station (101), said work station (101) is fixed on a vertical milling machine; a fastening means, wherein a stainless steel working material of required dimension is fastened to the said work station (101) by the said fastening means; a spindle (102), positioned above the work station (101) at a pre-defined height, wherein said spindle (102) is movable and height adjustable, wherein said spindle (102) is rotated at pre-defined speed; a collet, affixed inside the spindle; a probing pin, said probing pin is accommodated inside the said collet; a motor, said motor is operatively connected to the spindle (102); a controller, said controller controls the spindle (102) movement, rotating speed and height adjustment; a chamber (103), positioned on top of the work station (101), wherein said chamber (103) accommodates the fastened material, and are provided with a means for inlet (104) and a means for outlet (105); a cooling unit (106), said cooling unit (106) conducts a cooling medium to the chamber (103) through the said means for inlet (104) and the said means for outlet (105); and a power source, said power source supplies power to the said cooling unit (106), the said motor and the said work station (101).

In the preferred embodiment, wherein the said chamber (103) is a 4-wall chamber, wherein said pre-defined speed of the spindle (102) ranges from 50 rpm to 5000 rpm.

In the preferred embodiment of the present invention, wherein said probing pin is a non-deformable tool, wherein said probing pin is made of a harder material than the material whose surface microstructure is to be modified.

In the preferred embodiment of the present invention, the said apparatus (100) in particular the cooling unit (106) is further provided with a controlling means (107), said controlling means (107) controls the temperature, predefined rate and volume of the said cooling medium to be communicated to/from the chamber (103). Said cooling medium is a liquid coolant, wherein the coolants temperature ranges from −100 to +30 degree Celsius. Said predefined rate of flow of communication of cooling medium ranges from 1 ml/min to 500 ml/min.

In another embodiment of the present invention, the method of processing of the coarse grained stainless steel into a ultrafine grained stainless steel with enhanced wear resistance, corrosion resistance, biocompatibilty, cellular response and hem-compatibility, comprising the step of:
fastening the stainless steel working material to the work station (101) by means of the said fastening means;
supplying power to the work station (101), the motor, and the cooling unit (106) by means of the power source;
circulating the cooling medium from/to the cooling unit (106) to/from the chamber (103) through the said means for inlet (104) and the said means for outlet (105), to maintain a pre-defined temperature of the chamber, wherein the stainless steel working material is submerged in the cooling medium in the chamber (103);
maintaining the circulation of the cooling medium by means of controlling means (107), wherein the circulation of the cooling medium is maintained at the predefined rate by means of the controlling means (107);
rotating the said probing pin affixed to the spindle (102) at a pre-defined rotational speed, wherein the said motor provides rotational energy to the spindle (102), wherein said spindle (102) rotates at a pre-defined rotational speed, thereby rotating the said probing pin;
bringing the rotating probing pin in contact with the surface of the stainless steel working material, wherein the said probing pin penetrates through the material at a pre-defined depth;
progressing the penetrated rotating probing pin in longitudinal direction at a predefined velocity by means of said controller;
removing the penetrated rotating probing pin from the material upon completion of process; and
shutting off the power supply of power from the power source.

In the preferred embodiment of the present invention, wherein said pre-defined rotational speed of the probing pin ranges from 50 rpm to 5000 rpm, more preferably ranges from 1000 rpm to 2500 rpm. Wherein said pre-defined depth penetration of the probing pin through the material is limited up-to 50% thickness of the material. Wherein said pre-defined temperature of the cooling medium ranges from −100 degree Celsius to 30 degree Celsius. Wherein said predefined velocity of progression of penetrated rotating probing pin ranges from 1 mm/min to 500 mm/min. Wherein said predefined rate of the cooling medium is modulated based on the pre-defined rotational speed of the spindle, preferably said predefined rate of the cooling medium ranges from 10 ml/min to 1000 ml/min.

An improved stainless steel of enhanced wear resistance, corrosion resistance, biocompatibility, cellular response and hem-compatibility, comprises of, 0-0.08 wt. % of C, 0-5 wt % of Mn, 0-1.75 wt % of Si, 0-24 wt % of Cr, 0-18 wt % of Ni, 0-6 wt % of Mo, 0-0.075 wt % of P, 0-0.070 wt % of S, 0-0.60 wt % of N and balance Fe.

In an exemplary embodiment, the working material of stainless steel made to required dimensions. Said working material is stainless steel 3161 wherein the composition of said working material comprising of 0.03 wt. % C, 2 wt. % Mn, 0.75 wt. % Si, 16 wt % Cr, 10 wt % Ni, 2 wt % Mo, 0.045 wt % P, 0.030 wt % S, 0.10 wt % N and balance Fe. Said working material is of thickness more than 0.6 mm. The working material having coarse grained microstructure structure (121), is fastened on the work station (101) by fastening means. The cooling medium used is a mixture of distilled water and ethanol in equal proportion. Said cooling medium is communicated from the cooling unit (106) to the said chamber (103) through the said means for inlet (104). The pre-defined temperature of the cooling medium in the chamber is set to be 0 degree Celsius. The cooling medium circulates at the predefined rate, from/to the chamber (103) to/from the cooling unit (106) through the said means for outlet (105) and the said means for inlet (104), to maintain the pre-defined temperature of the chamber. Said predefined rate is set at 100 ml/min by means of said controller. Said controller is also used to set the pre-defined rotational speed of the spindle (102), wherein the pre-defined rotational speed of the spindle is set as 1800 rpm. Said probing pin affixed to the spindle (102). Said probing pin a non-deformable tool is made of tungsten carbide material. Wherein the probing pin is harder than the working material. The rotating probing pin is brought in contact with the surface of the working material. The rotating probing pin penetrates through the working material through a pre-defined depth. Said predefined depth is 0.3 mm. The penetrated rotating probing pin progresses in the longitudinal direction at the predefined velocity. Said predefined velocity for the progression of the penetrated rotating probing pin is 20 mm/min. Upon processing of the surface (123) of the working material in the longitudinal direction, said penetrated rotating probing pin is removed from the material and the supply of power from the power source is discontinued. The above process develops the ultrafine grained microstructure (122) on the surface of the working material. Thus, wear resistance, corrosion resistance, biocompatibility, cellular response and hem-compatibility is enhanced and the improved working material is developed. The processed stainless steel working material showed significant improvement in terms of wear and localized corrosion as well as improved cellular activity in simulated body conditions. Following is the list of improvements of the improved stainless steel,
1. Wear: Wear volume loss (mm³) of the processed stainless steel working material is reduced by 50% compared to the unprocessed stainless steel working material.

Significantly high wear resistance of the improved stainless steel can prevent degradation of implants made of improved stainless steel due to wear over a period of time.
2. Corrosion: Corrosion ( ) in simulated body fluid decreased by nearly 50% and localized pit initiation and propagation resistance (Pitting potential, mV) increased by 20% and 100% respectively. Limiting the localized corrosion will prevent premature failure and improves reliability of the implant made of improved stainless steel.
3. Cellular Response: Cellular response was obtained in terms of following:
   a. Platelet Adhesion and Plasma Adsorption: The processed stainless steel working material shows significant drop in platelet adhesion from 43% for the unprocessed stainless steel working material to 7% for the processed stainless steel working material. In addition, the processed stainless steel showed only 13% fibrinogen (protein) adsorption compared to 55% for the unprocessed steel signifying high thromboresistance of the processed material. The data suggests very less platelet adhesion and thus having negligible chances of platelet activation leading to blot clot or arterial blockage.
   b. Hem-compatibility: Validation of the hemolytic assay of the processed stainless steel working material demonstrated negligible haemolytic effect (less than 5%)
   c. Morphological Analysis of Mammalian Cultured Monolayer Cells: The processed stainless steel working material retained healthy elongated morphology with intact actin filaments. In contrast, cells grown on unprocessed stainless steel working material showed distorted actin structure, rounded morphology with decreased fluorescence intensity suggesting prominent morphological aberration
   d. Cell Metabolic Viability and Cytotoxicity: The processed stainless steel working material showed very less cytotoxicity (approximately 5%) and significantly high metabolic viability, as compared to unprocessed stainless steel working material.

It will be apparent to a person skilled in the art that the above description is for illustrative purposes only and should not be considered as limiting. Various modifications, additions, alterations, and improvements without deviating from the spirit and the scope of the invention may be made by a person skilled in the art.

1. A method for processing the coarse grained stainless steel into an ultrafine grained stainless steel having enhanced wear resistance, corrosion resistance, biocompatibility, cellular response and hem-compatibility, comprising of,
a. fastening of a stainless steel working material to a work station by a fastening means;
b. supplying power to a motor, and a cooling unit by means of a power source;
c. circulating a cooling medium from/to the cooling unit to/from a chamber through a means for inlet and a means for outlet, to maintain a pre-defined temperature of the chamber, wherein the stainless steel working material is submerged by the cooling medium in the chamber;
d. maintaining the circulation of the cooling medium by means of a controlling means, wherein the circulation of the cooling medium is maintained at a predefined flow rate by means of the said controlling means;
e. rotating a probing pin affixed to a spindle at a pre-defined rotational speed, wherein the said motor provides rotational energy to the spindle, wherein said spindle rotates at a pre-defined rotational speed, thereby rotating the said probing pin;
f. bringing the rotating probing pin in contact with the surface of the stainless steel working material, wherein the said probing pin penetrates through the material at a pre-defined depth;
g. progressing the penetrated rotating probing pin in longitudinal direction at a predefined velocity by means of the said controller;
h. removing the penetrated rotating probing pin from the material upon completion of process; and
i. shutting off the power supply of power from the power source.

2. A method for processing the coarse grained stainless steel into an ultrafine grained stainless steel, as claimed in claim 1, said pre-defined rotational speed ranges from 50 rpm to 5000 rpm, more preferably 1000 rpm to 2500 rpm.

3. A method for processing the coarse grained stainless steel into an ultrafine grained stainless steel, as claimed in claim 1, said pre-defined depth of penetration of the rotating probing pin through the working material is up to 50% thickness of the stainless steel working material.

4. A method for processing the coarse grained stainless steel into an ultrafine grained stainless steel, as claimed in claim 1, said pre-defined temperature of the cooling medium in the said chamber ranges from −100 degree Celsius to 30 degree Celsius.

5. A method for processing the coarse grained stainless steel into an ultrafine grained stainless steel, as claimed in claim 1, said predefined flow rate of the cooling medium is modulated based on the pre-defined rotational speed of the spindle.

6. A method for processing the coarse grained stainless steel into an ultrafine grained stainless steel, as claimed in claim 1, wherein the predefined flow rate of the cooling medium ranges from 10 ml/min to 1000 ml/min.

7. An apparatus processing the coarse grained stainless steel into an ultrafine grained stainless steel having enhanced wear resistance, corrosion resistance, biocompatibility, cellular response and hem-compatibility, comprising of,
a. a work station, for processing the stainless steel working material;
b. a fastening means, wherein the stainless steel working material of required dimension and thickness is fastened to the work station by means of said fastening means;
c. a spindle, positioned above the work station at a pre-defined height, said height of the spindle from the work station is adjustable, said spindle is movable, wherein the spindle is rotated at predefined speed;
d. a collet, affixed inside the spindle;
e. a probing pin, accommodated within the collet;
f. a motor, said motor is operatively connected to the spindle, wherein said motor provides rotational energy to the spindle;
g. a controller, said controller controls the movement, rotation speed and the height adjustment of the said spindle;
h. a chamber, positioned on top of the work station, wherein said chamber accommodates the fastening means, coolant, working material held in place by means of the said fastening means, a means for inlet and a means for outlet;
i. a cooling unit, said cooling unit communicates a cooling medium to the said chamber through the said means for inlet and the said means for outlet; and
j. a power source, said power source supplies power to the said cooling unit and said motor.

8. An apparatus processing the coarse grained stainless steel into an ultrafine grained stainless steel, as claimed in claim 7, wherein the said cooling unit is further provided with a controlling means, for controlling the temperature, predefined flow rate and volume of the said cooling medium to be circulated to/from the chamber.

9. An apparatus processing the coarse grained stainless steel into an ultrafine grained stainless steel, as claimed in claim 7, wherein said work station is fixed on table of a vertical milling machine.

10. An apparatus processing the coarse grained stainless steel into an ultrafine grained stainless steel, as claimed in claim 7, wherein said chamber is a 4-wall chamber.

11. An apparatus processing the coarse grained stainless steel into an ultrafine grained stainless steel, as claimed in claim 7, said pre-defined speed of the spindle ranges from 50 rpm to 5000 rpm, more preferably 1000 rpm to 2500 rpm.

12. An apparatus processing the coarse grained stainless steel into an ultrafine grained stainless steel, as claimed in claim 7, said probing pin is made of a non-deformable material harder than that of the working material.

13. An apparatus processing the coarse grained stainless steel into an ultrafine grained stainless steel, as claimed in claim 7, wherein said probing pin is made of any non-deformable material including but not limited to tungsten carbide.

14. An apparatus processing the coarse grained stainless steel into an ultrafine grained stainless steel, as claimed in claim 7, said cooling medium is a fluid coolant.

15. An apparatus processing the coarse grained stainless steel into an ultrafine grained stainless steel, as claimed in claim 7, wherein said temperature of cooling medium ranges from −100 to +30 degree Celsius.

16. An apparatus processing the coarse grained stainless steel into an ultrafine grained stainless steel, as claimed in claim 7, said predefined flow rate of cooling medium ranges from 1 ml/min to 500 ml/min.

17. An ultrafine grained stainless steel having enhanced wear resistance, corrosion resistance, better biocompatibility, better cellular response and hem-compatibility, comprising of: 0-0.08 wt. % of C; 0-5 wt. % of Mn; 0-1.75 wt. % of Si; 0-24 wt. % of Cr; 0-18 wt. % of Ni; 0-6 wt. % of Mo; 0-0.075 wt. % of P; 0-0.070 wt. % of S; 0-0.60 wt. % of N; and balance Fe.
